(19) United States
(12) Patent Application Publication
(10) Pub. No.: US 2011/0188812 A1
(43) Pub. Date: Aug. 4, 2011

(54) OPTICAL FIBER CONNECTOR

(75) Inventors: SHAO-YOU HAN, Shenzhen City (CN); PO-HSUN SHEN, Tu-Cheng (TW); BING SU, Shenzhen City (CN); XIAO-BO ZHAO, Shenzhen City (CN)

(73) Assignees: HON FU JIN PRECISION INDUSTRY (Shenzhen) CO., LTD., Shenzhen City (CN); HON HAI PRECISION INDUSTRY CO., LTD., Tu-Cheng (TW)

(21) Appl. No.: 12/960,639

(22) Filed: Dec. 6, 2010

(30) Foreign Application Priority Data
Feb. 1, 2010 (CN) 201010301008.3

(51) Int. Cl. G02B 6/36

(52) U.S. Cl. 385/77

(57) ABSTRACT

An optical fiber connector includes a splice tube, a clamping member, an outer housing, and an inner housing. The inner housing is detachably and adjustably assembled with the outer housing. The clamping member is received within the outer housing and adjustably clamped between the outer housing and the inner housing. The clamping defines a through hole coaxially communicating with the outing housing and the inner housing. The splice tube is assembled within the inner housing with one end connecting with the clamping member coaxially.

### BACKGROUND

1. Technical Field

The present disclosure relates to connectors, and particularly, to an optical fiber connector.

2. Description of Related Art

Optical fiber connectors are an essential part of the application of optical fiber based communication systems. For example, such connectors can be used to join segments of fibers for longer lengths, to connect fibers to active devices such as transceivers, detectors and repeaters, or to connect fibers to passive devices such as switches or attenuators. However, commonly used optical fiber connectors have complex structure and cannot be adjusted, thus the optical fiber cable is easily detached or separated from the optical fiber connector over time.

Therefore, there is room for improvement in the art.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the optical fiber connector. Moreover, in the drawings like reference numerals designate corresponding parts throughout the several views. Wherever possible, the same reference numerals are used throughout the drawings to refer to the same or like elements of an embodiment.

FIG. 1 is an assembled isometric view of a first embodiment of an optical fiber connector.

FIG. 2 is an exploded isometric view of the optical fiber connector shown in FIG. 1.

FIG. 3 is an enlarged cross-section of the optical fiber connector taken along line III-III of FIG. 1.

FIG. 4 is an assembled isometric view of a second embodiment of an optical fiber connector.

FIG. 5 is an exploded isometric view of the optical fiber connector shown in FIG. 4.

FIG. 6 is similar to FIG. 5, but viewed from another aspect.

FIG. 7 is an enlarged cross-section of the optical fiber connector taken along line VII-VII of FIG. 4.

### DETAILED DESCRIPTION

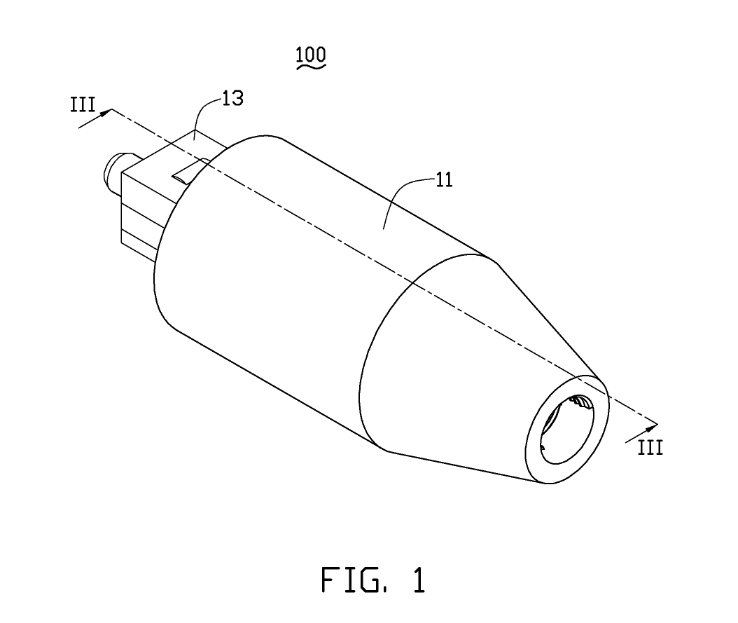

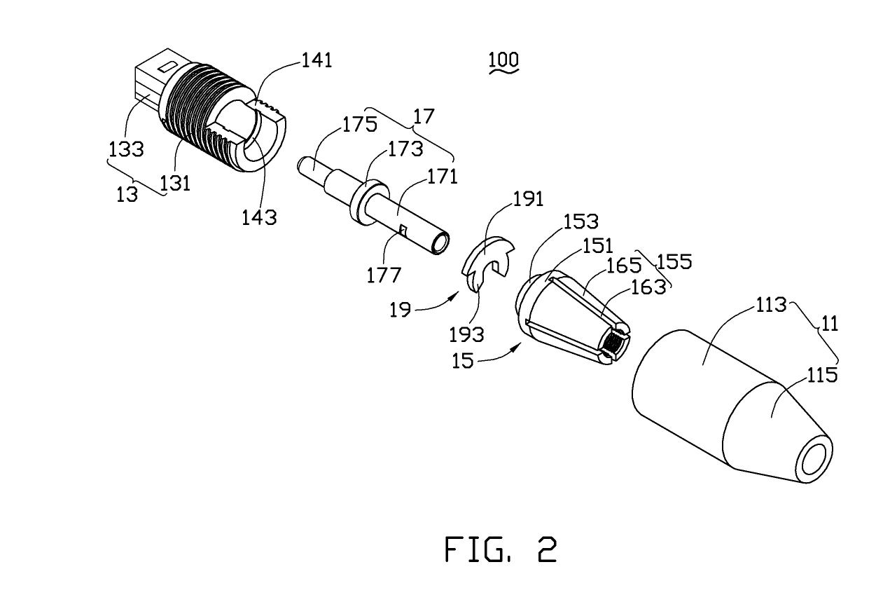

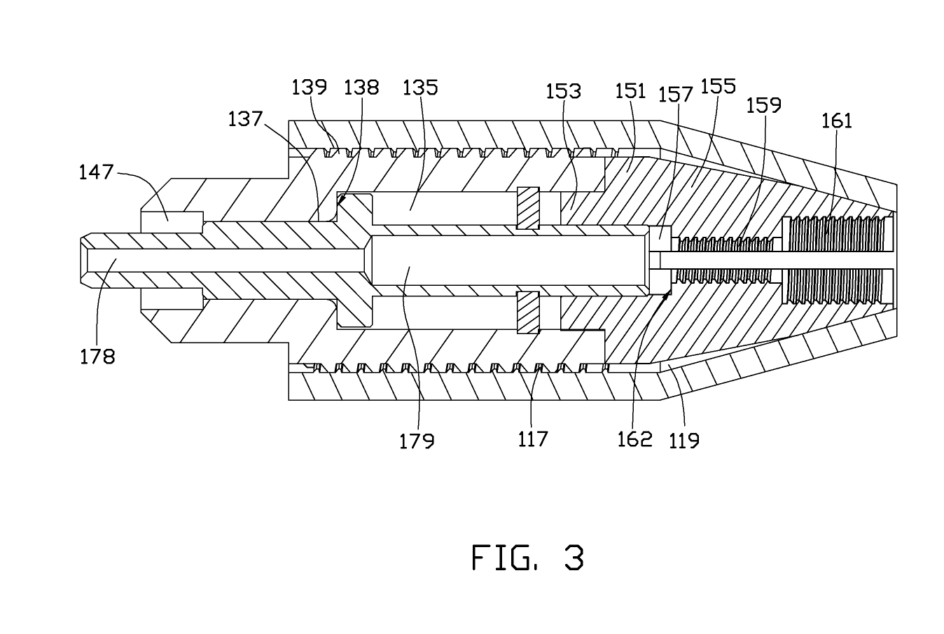

Referring to FIGS. 1 through 3, a first embodiment of an optical fiber connector 100 includes an outer housing 11, an inner housing 13, a clamping member 15, a splice tube 17, and a clip piece 19. The outer housing 11 includes a fixing portion 113 and a sleeve portion 115. The fixing portion 113 is substantially a hollow cylinder and defines an inner threading 117 in an inner surface of the fixing portion 113. The sleeve portion 115 is substantially hollow, tapered, and extends from one distal end of the fixing portion 113 with a diameter decreasing away from the fixing portion 115. The sleeve portion 115 defines a tapered receiving hole 119 (see FIG. 3) therethrough communicating with the fixing portion 113.

The inner housing 13 is detachably assembled with the outer housing 11, and includes a main body 131 and a plug 133 formed at a distal end of the main body 131. The main body 131 is substantially a hollow cylinder with an outer diameter substantially the same as the inner diameter of the fixing portion 113 of the outer housing 11. The main body 131 includes an outer threading 139 formed at the outer periphery thereof corresponding to the inner threading 117 of the outer housing 11, such that the outer threading 139 is adjustably and detachably received on the inner threading 117.

An accommodating hole 135 and an output hole 147 are respectively defined in a distal end of the main body 131 and a distal end of the plug 133, opposite each other coaxially. The diameter of the accommodating hole 135 exceeds that of the output hole 147. A connecting hole 137 is defined between the accommodating hole 135 and the output hole 147, and through the bottom surface 138 of the accommodating hole 135 to coaxially communicate with the output hole 147. In the illustrated embodiment, the diameter of the connecting hole 137 is less than the diameter of the output hole 147 as shown in FIG. 3. A curved cutout 141 is defined at the distal end of the main body 131 away from the plug 133, to communicate with the accommodating hole 135. A curved latching slot 143 is defined in the inner periphery wall of the main body 131 with two ends thereof communicating with the cutout 141.

The clamping member 15 is received within the outer housing 11 and adjustably clamped between the outer housing 11 and the inner housing 13. The clamping member 15 includes a main portion 151, a latching portion 153 formed at one end of the main portion 151 and a clamping portion 155 formed at the opposite end of the main portion 151. The main portion 151 is substantially cylindrical with a diameter substantially the same as that of the inner diameter of the fixing portion 113 of the outer housing 11. The latching portion 153 is cylindrical and protrudes from one distal end of the main portion 151 coaxially. The diameter of the latching portion 153 is less than that of the main portion 151 but substantially the same as the diameter of the accommodating hole 135 enabling the latching portion 153 to be detachably latched into the accommodating hole 135 of the inner housing 13.

An assembly hole 157 is defined through the latching portion 153 and the main portion 151 coaxially. The diameter of the assembly hole 157 is substantially the same as that of the connecting hole 137 of the inner housing 13. The clamping portion 155 is substantially tapered extending from the opposite end of the main portion 151 with a diameter thereof decreasing away from the main portion. The dimension of the clamping portion 155 is substantially the same as that of the inner receiving hole 119 of the outer housing 11. A first threaded hole 159 is defined in the clamping portion 155 adjacent to the main portion 151 end to communicate with the assembly hole 157 coaxially. A diameter of the first threaded hole 159 is less than that of the assembly hole 157, enabling a fiber cable to pass therethrough. A second threaded hole 161 is defined in the opposite end of the clamping portion 155 to coaxially communicate with the first threaded hole 159. The diameter of the second threaded hole 161 exceeds that of the first threaded hole 159. Several grooves 163 are defined through the outer periphery wall of the clamping portion 155 from the unction of the main portion 151 and the clamping portion 155 to the distal end of the clamping portion 155, thereby forming several elastic grip jaws 165 spaced from each other.

The splice tube 17 is a substantially hollow stepped shaft with one end assembled within the inner housing 13, the opposite end thereof being assembled to the clamping member 15. The splice tube 17 includes a main shaft 171, a resisting flange 173, and a guiding shaft 175. The main shaft 171 is cylindrical and has an outer diameter substantially the same as the inner diameter of the assembly hole 157 of the clamping member 15. Two latching grooves 177 are oppositely defined in two sides of the outer periphery wall of the main shaft 171 and located adjacent to one end of the main shaft 171. The resisting flange 173 is substantially annular and extends out from the outer periphery wall of the substantial center of the main shaft 171. The outer diameter of the resisting flange 173 is substantially the inner diameter of the accommodating hole 135 of the inner housing 13. The guiding shaft 175 is substantially cylindrical and extends out from a distal end of the main shaft 171 away from the latching grooves 177. The diameter of the guiding shaft 175 is less than that of the main shaft 171. A first axial hole 178 is defined within the splice tube 17 from the distal end of the guiding shaft 175 toward the opposite resisting flange 173 end. A second axial hole 179 is defined within the main shaft 171 from a distal end thereof toward the end of the guiding shaft 175 and communicates with the first axial hole 178 at a position within the substantially the resisting flange 173. In the illustrated embodiment, the diameter of the first axial hole 178 is less than that of the second axial hole 179.

The clip piece 19 is substantially C-shaped and includes a resisting portion 191 and two curved clip arms 193 extending from two ends of the resisting portion 191 respectively. The clip piece 19 is detachably assembled in the latching slot 143 of the inner housing 14 and two clip arms 193 thereof latch into the two latching grooves 177 of the splice tube 17.

During assembly of the optical fiber connector 100, the clamping member 15 is assembled within the outer housing 11, the clamping portion 155 thereof is received within the receiving hole 119 of the sleeve portion 115 and the outer peripheral wall of the clamping portion 155 tightly resists the inner wall of receiving hole 119. The main portion 151 and the latching portion 153 of the clamping member 15 are positioned within the fixing portion 113 adjacent to the receiving hole 119 end. The end of the guiding shaft 175 of the splice tube 17 is received in the accommodating hole 135 of the inner housing 13 and passes through the connecting hole 137 and the output hole 147 and is partially exposed to the outer side of the plug 133 end of the inner housing 13. The resisting flange 173 resists the corresponding bottom surface 138 of the accommodating hole 135. The clip piece 19 is latched into the latching slot 143 of the inner housing 14 from the cutout 141 and the two clip arms 193 latch into the corresponding two latching grooves 177 of the main shaft 171, such that the splice tube 17 is assembled to the inner housing 13. Finally, the outer housing 11 together with the clamping member 15 is assembled to the inner housing 13. The distal end of the main shaft 171 aligns with and is received in the assembly hole 157 of the clamping member 15. The outer threading 139 of the main body 131 engages the corresponding inner threading 117 of the outer housing 11, such that the main body 131 of the inner housing 13 is received in the fixing portion 113 of the outer housing 11 to finish the assembly of the optical fiber connector 100 (shown in FIG. 3).

Referring to FIG. 3, in use, the optical fiber connector 100 is assembled to one end of an optical fiber cable (not shown) for connection with other devices. First, the optical fiber connector 100 is loosened by reverse rotating the inner housing 13 relative to the outer housing 11, and one end of the optical fiber cable passes through the receiving hole 119 of the outer housing 11, the second threaded hole 161, the first threaded hole 159 of the clamping member 15, and the second axial hole 179 of the splice tube 17, to be received in the first axial hole 178 of the splice tube 17. Finally, the inner housing 13 is rotated relative to the outer housing 11 to tighten the inner housing 13 toward the outer housing 11. The outer threading 139 of the main body 131 of the inner housing 13 engages the corresponding inner threading 117 of the outer housing 11. Meanwhile, the distal end of the main body 131 resists the main portion 151 of the clamping member 15, thereby pushing the clamping member 15 move toward the distal end of the outer housing 11. The elastic grip jaws 165 of the clamping member 15 tightly clamp the optical fiber cable passing through the clamping member 15, whereby the optical fiber cable is tightly assembled to the optical fiber connector 100.

It is to be understood that the resisting flange 173 of the splice tube 17 can be omitted.

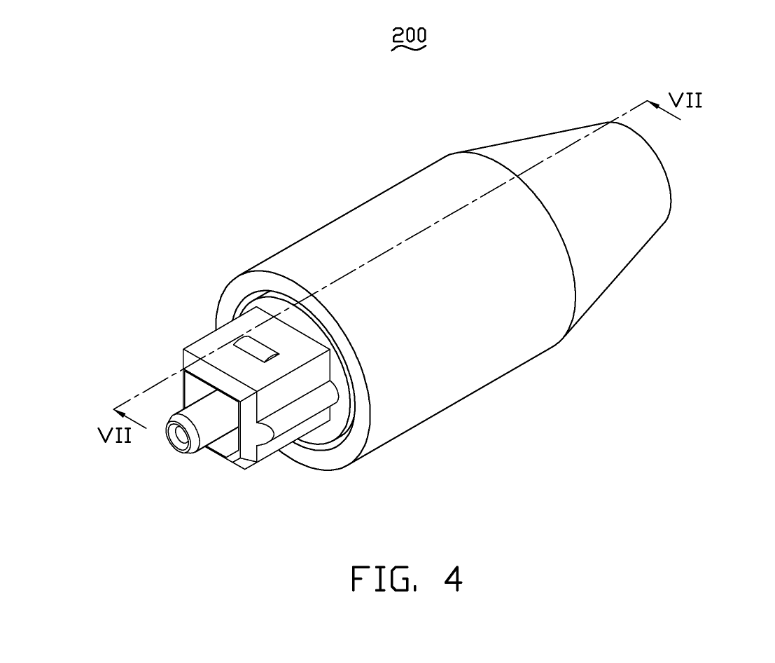

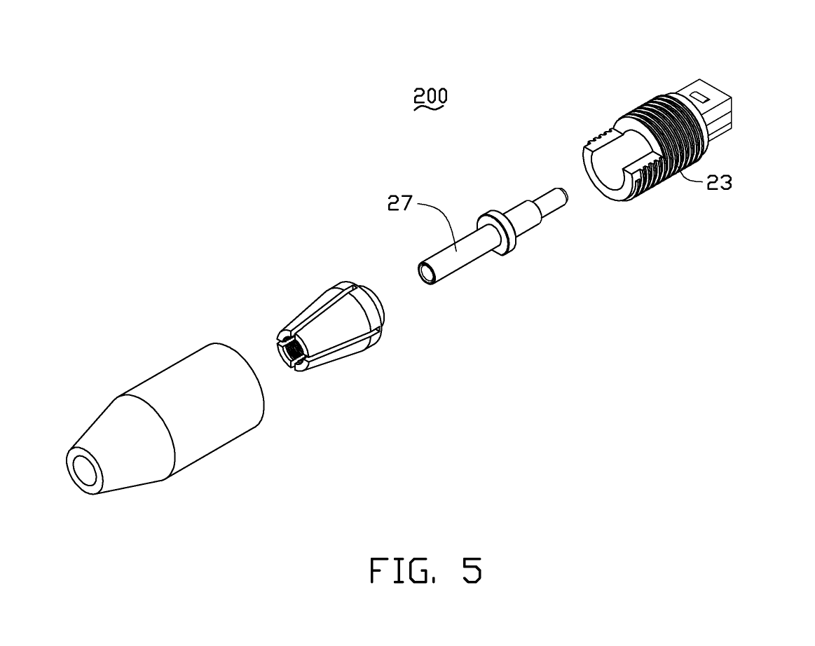

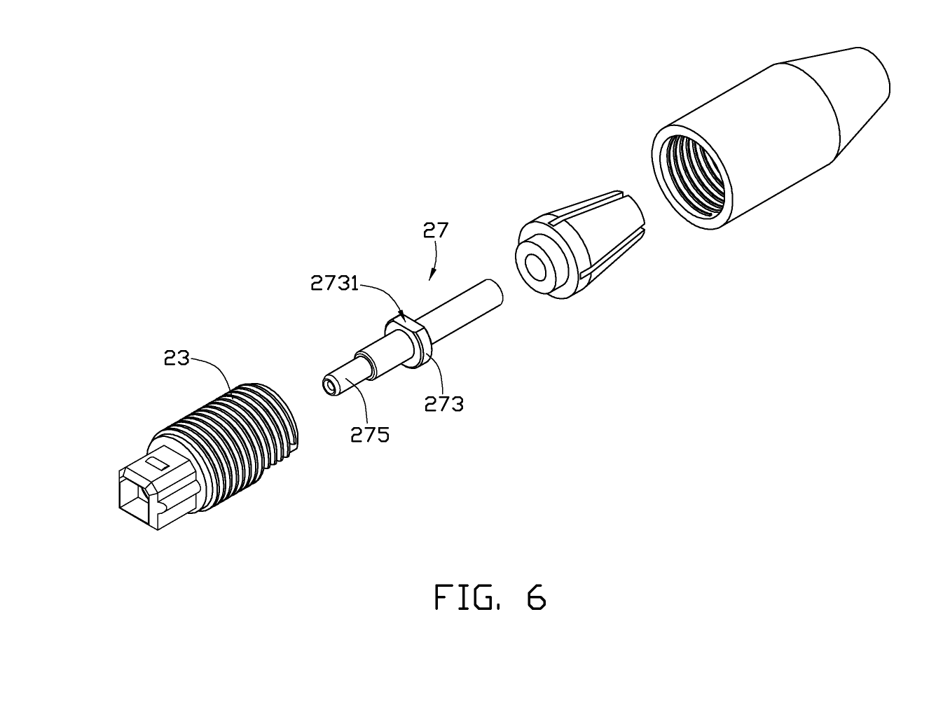

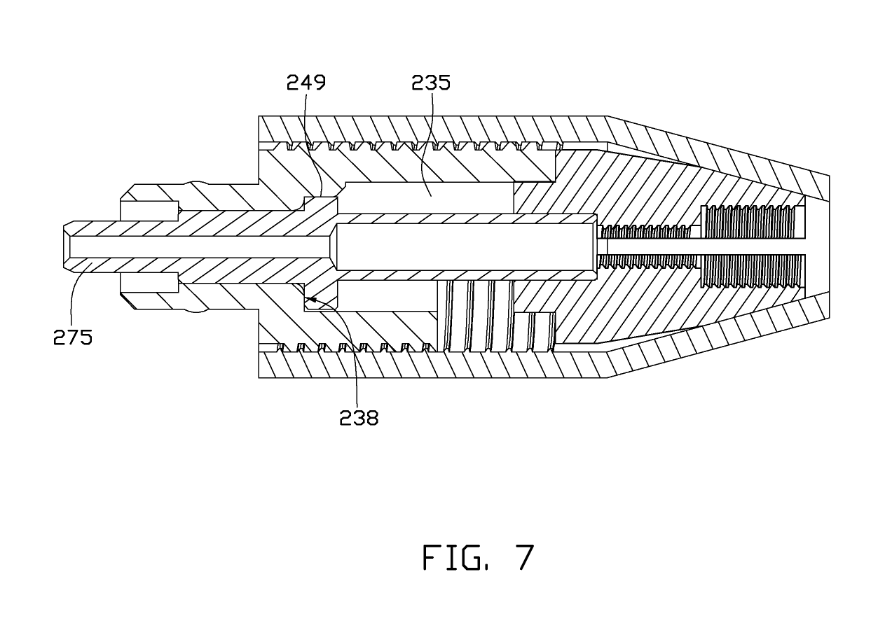

Also referring to FIG. 4 through 7, an optical fiber connector 200 according to a second embodiment is similar to the optical fiber connector 100 except the clip piece 19 is omitted, the inner housing 23 does not define the curved latching slot 143 therein, and the splice tube 27 does not define the latching grooves 177. The resisting flange 273 of the splice tube 27 is partially cut to form a flat surface 2731 thereby preventing the splice tube 27 from rotating relative to the inner housing 23. A protrusion 249 is formed within the accommodating hole 235 of the inner housing 23 corresponding to the flat surface 2731 of the splice tube 27. During assembly of the splice tube 27, the end of the guiding shaft 275 is received in the accommodating hole 235 of the inner housing 23 and finally partially exposed to the outer side of the inner housing 23. The resisting flange 273 resists the corresponding bottom surface 238 of the accommodating hole 235. The flat surface 2731 of the resisting flange 273 tightly resists the corresponding protrusion 249, such that the splice tube 27 is assembled to the inner housing 23.

It is to be understood, however, that even through numerous characteristics and advantages of the disclosure have been set forth in the foregoing description, together with details of the structure and function of the present disclosure, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. An optical fiber connector, comprising:
a hollow shaped outer housing;
a hollow inner housing detachably and adjustably assembled with the outer housing;
a clamping member received within the outer housing and adjustably clamped between the outer housing and the inner housing, the clamping member defining a through hole coaxially communicating with the outing housing and the inner housing; and
a splice tube assembled within the inner housing with one end connecting with the clamping member coaxially.

2. The optical fiber connector of claim 1, wherein the outer housing comprises a fixing portion defining an inner threading in the inner surface thereof; the inner housing comprising a hollow cylindrical main body defining an outer threading corresponding to the inner threading of the outer housing, such that the main body of the inner housing is adjustably and detachably received on the fixing portion of the outer housing.

3. The optical fiber connector of claim 2, wherein the outer housing further comprises a sleeve portion formed at one distal end of the fixing portion and defines a tapered receiving hole through the sleeve portion to communicate with the fixing portion; the clamping member comprises a main portion and a tapered clamping portion, the clamping portion being received within the receiving hole of the sleeve portion and tightly resists the inner wall of the receiving hole; the main portion is received within the fixing portion and tightly pressed by the distal end of the main body of the inner housing.

4. The optical fiber connector of claim 3, wherein the dimension of the clamping portion is substantially the same as that of the inner receiving hole of the outer housing.

5. The optical fiber connector of claim 3, wherein the clamping portion defines several grooves through the outer periphery wall thereof from the junction of the main portion and the clamping portion to the distal end of the clamping portion, thereby forming several elastic grip jaws spaced from each other.

6. The optical fiber connector of claim 5, wherein the inner housing further comprises a plug formed at the distal of the main body, an accommodating hole and an output hole are respectively defined in the other distal end of the main body and the opposite distal end of the plug coaxially, a connecting hole is defined through the bottom surface of the accommodating hole to connect the accommodating hole with the output hole, the splice tube is a substantially hollow stepped shaft with one end assembled within the main body of the inner housing, and the opposite end thereof assembled to the clamping member.

7. The optical fiber connector of claim 6, wherein the splice tube comprises a hollow main shaft, a resisting flange, and a hollow guiding shaft formed at a distal end of the main shaft, the resisting flange extending out from an outer periphery wall of the main shaft; the guiding shaft passes through the accommodating hole and is partially exposed from the plug end, the opposite distal end of the main shaft is exposed from the main body end and received in the clamping member, and the resisting flange accordingly resists against the bottom of the accommodating hole.

8. The optical fiber connector of claim 7, wherein the distal end of the main body away from the plug defines a cutout communicating with the accommodating hole, and a latching slot defined in the inner periphery wall of the accommodating hole with two ends thereof communicating with the cutout; the optical fiber connector further comprises a clip piece assembled within the latching slot and latching with the main shaft of the splice tube.

9. The optical fiber connector of claim 8, wherein the main shaft of the splice tube defines two latching grooves at two sides of the outer periphery wall thereof corresponding to the latching slot; the clip comprises a resisting portion and two clip arms extending from two ends of the resisting portion respectively; the resisting portion is detachably assembled in the latching slot, and the two clip arms respectively latch into the corresponding two latching grooves of the splice tube.

10. The optical fiber connector of claim 7, wherein the clamping member further comprises a latching portion formed at the distal end of the main portion opposite to the clamping portion, the latching portion defines an assembly hole to communicate with the clamping portion, the latching portion detachably latches into the accommodating hole of the main body of the inner housing, and the distal end of the main body resists against the corresponding cross section of the main portion; the distal end of the main shaft is received within the assembly hole of the latching portion.

11. The optical fiber connector of claim 7, wherein the resisting flange defines a flat surface, a protrusion is formed within the accommodating hole of the inner housing and resists the flat surface to prevent the splice tube from rotating relative to the inner housing.

12. An optical fiber connector, comprising:
a hollow outer housing defining a first threading;
a hollow inner housing defining a second threading, the inner housing being detachably assembled to the outing housing via the second threading engaging with the first threading of the inner housing;
a hollow clamping member adjustably assembled between the outing housing and the inner housing, one end of the clamping member resisting against an inner wall of the outing housing, and the other end of the clamping member being resisted by the inner housing clamping an optical fiber cable; and
a splice tube assembled within the inner housing with one end connecting with the clamping member coaxially, and the opposite end exposed from one end of the inner housing, enabling the optical fiber cable passing through.

13. The optical fiber connector of claim 12, wherein the outer housing comprises a fixing portion and a hollow sleeve portion formed at one distal end of the fixing portion; the second threading is defined in the inner surface of the fixing portion; the clamping member includes a main portion and a tapered clamping portion received within the sleeve portion tightly resisting the inner wall of the sleeve portion; the main portion is received within the fixing portion and tightly resisted by the distal end of the inner housing.

14. The optical fiber connector of claim 13, wherein the inner housing comprises a hollow cylindrical main body, the first threading is defined in the outer periphery wall of the main body of the outer housing, and the distal end of the main body tightly resists the main portion of the clamping member.

15. The optical fiber connector of claim 14, wherein the clamping portion defines several grooves through the outer periphery wall thereof from the junction of the main portion and the clamping portion to the distal end of the clamping portion, thereby forming several elastic grip jaws spaced from each other.

16. The optical fiber connector of claim 14, wherein the inner housing further comprises a plug formed at the distal of the main body, a stepped axial accommodating hole defined through the inner housing from one end of the main body to the distal end of the plug, the splice tube being a substantially hollow stepped shaft assembled within the inner housing; two ends of the splice tube are respectively exposed from two ends of the inner housing.

17. The optical fiber connector of claim 16, wherein the clamping member further comprise a latching portion formed at the distal end of the main portion opposite to the clamping portion, the latching portion defines an assembly hole to communicate with the clamping portion, the latching portion detachably latches into the accommodating hole of the main body of the inner housing, and the distal end of the main body resists against the corresponding cross section of the main portion; the distal end of the splice tube is received within the assembly hole of the latching portion.

18. The optical fiber connector of claim 17, wherein the distal end of the main body away from the plug defines a cutout communicating with the accommodating hole, and a latching slot is defined in the inner periphery wall of the accommodating hole with two ends thereof communicating with the cutout; the optical fiber connector further comprises a clip piece assembled within the latching slot and latching with the splice tube.

19. The optical fiber connector of claim 18, wherein the splice tube defines two latching grooves corresponding to the latching slot; the clip comprises a resisting portion and two clip arms extending from two ends of the resisting portion respectively; the resisting portion is detachably assembled in the latching slot, the two clip arms respectively latch into the corresponding two latching grooves of the splice tube.
